(19) United States
(12) Patent Application Publication
(10) Pub. No.: US 2008/0207322 A1
(43) Pub. Date: Aug. 28, 2008

(54) Method, System and Computer-Readable Code For Providing a Computer Gaming Device

(76) Inventor: Yosef Mizrahi, Alfey Menashe (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/909,157

(22) PCT Filed: Mar. 8, 2006
(86) PCT No.: PCT/IL2006/000308

§ 371 Date: Sep. 20, 2007

Related U.S. Application Data
(60) Provisional application No. 60/663,623, filed on Mar. 21, 2005.

(51) Int. Cl. G06F 17/00

(52) U.S. Cl. 463/32; 463/42

(57) ABSTRACT

A system, method and computer readable code for providing a single player and/or a multi-player gaming environment is provided. Each user is provided with a client device having an input module and display screen. An application server array receives data indicative of game commands from each client device. Residing in the application server array is a game engine which maintains a virtual gaming universe including one or more of user-controllable gaming characters. The gaming engine is operative to associate each user-controlled gaming character with game commands received from a respective client device of the plurality of devices. At the application server array, a one or more streams of videos are rendered. In some embodiments, each video stream represents a view associated with a different game character. Each video stream is sent over a communications link to a respective client device. In some embodiments, the communications link is a switched network, such as a packet switched network of a circuit switched network.

### FIELD OF THE INVENTION

The present invention relates to client-server systems and in particular to single user and multi-player gaming systems where rendered video is served to one or more client devices.

### BACKGROUND

Multi-player video gaming systems are known in the art, for example console-based systems such as the Xbox, manufactured by Microsoft Corporation of Redmond, Wash., the PlayStation 2, manufactured by Sony Corporation of Japan and the GameCube, manufactured by Nintendo Corp. Other gaming systems include the N-Gage manufactured by Nokia Corporation of Finland which resides in a device that also provides cellular telephone functionality. Other multi-player gaming systems may reside in one or more microcomputers (for example, Quake or Doom from id Software).

Typically, gaming systems provide an animated virtual universe or landscape (typically a 3-D world). Within this virtual universe resides a plurality of user-controllable animated objects or user-controllable gaming characters, as well as optional computer-controlled gaming characters and other animated objects.

When playing multi-player video gaming systems, each human player typically uses a control device (for example, a joystick, or a gamepad or a keyboard) which transmits game commands to one or more game servers (for example, a microcomputer or a dedicated game console). These game commands are operative to control the actions of the user-controllable gaming character associated with the respective control device. In other words, each user-controllable gaming character within the virtual gaming universe is typically configured to behave in accordance with the commands received from the respective game console controlling that particular gaming character (typically, at any given time, there is a one-to-one relationship between each gaming character and each game control device).

For the present application, the term “gaming character” is used in a broad sense to include both animated human-like or animal-like virtual characters (for example, fighters and sportsmen, or “fantasy” characters such as dragons) as well as virtual simulated mobile vehicles (for example, space ship, airplane, combat vehicle or motorized vehicle). In some examples, the virtual character has a modifiable locations and/or orientation within the virtual gaming universe. Some, but not all virtual characters, are “three-dimensional characters” possessing “internal degrees of freedom” (for example, a tank with several orientable guns, or a human fighter with both orientable and bendable legs and arms).

It is noted that today's game consumer demands realistic graphics, a “believable” virtual universe, and tantalizing special effects. Many market observers attribute the success of game console systems such as the Xbox to their ability to provide a “rich” game experience with realistic graphical rendering of the virtual worlds of the game. There is an ongoing need for systems and methods capable of duplicating and improving this rich game experience on devices (for example, portable devices including but not limited to cell phones and PDAs) with fewer computational resources, for example due to cost, power, size and/or weight constraints.

### SUMMARY OF THE INVENTION

Some or all of the aforementioned needs, and other needs, are satisfied by several aspects of the present invention.

A number of systems and methods for providing applications services and/or games services to one or more client devices are now disclosed for the first time.

It is now disclosed for the first time a server-based system for providing gaming services to a plurality of client devices. The presently disclosed system includes (a) an application server array adapted to effect a data transfer with each of plurality of client devices that are each separate from the server array, (b) an input data aggregator (for example, residing in the application server array) for receiving data indicative of game commands from each of the plurality of client devices, (c) a game engine (for example, residing at least in part, or entirely, in the application server array) for maintaining a virtual gaming universe (for example, a virtual 2-D or 3-D animated world) including a plurality of user-controllable gaming characters, the gaming engine operative to associate each gaming character with game commands received from a respective client device (e.g. such that each respective gaming character obeys commands from the respective client device, e.g. so that input data of each client device controls the actions of the respective user-controllable gaming character), and (d) a rendering engine residing separately from the client devices (for example, residing in the application server array) for generating from said virtual gaming universe a plurality of video streams, each video stream representing a view associated with a respective game character.

Not wishing to be bound by theory, it is noted that in accordance with some embodiments of the present invention, video output is rendered on the game server (i.e. in the application server array), obviating the need to render the video output on the client device. This offloads much of the load associated with providing the gaming environment from the client device to the application server arrays which are separate from the client devices. In some examples, this may enable client devices which lack the resources provide a specific gaming environment (for example, because the client device lacks the computations resources to render “rich” video) to nevertheless, provide an interface to this gaming environment, and to allow the user to access this gaming environment using the data input (i.e. phone keypad, joystick, gaming pad) and screen of the client device.

According to exemplary embodiments, the game software may be installed only within the application server, and, for example, not on the client device. This allows for a user to access a game service while leaving a minimal footprint, or no footprint within the client device. In exemplary embodiments, allowing the game engine and/or the video rendering components to reside off of the client device (for example, in the applications server) may enable for client devices to provide access to gaming environments while saving physical driver storage memory space memory, and/or power consumption, and/or other resources.

According to some embodiments, the multi-video rendering engine is configured to render one or more video streams directly from said virtual gaming universe.

According to some embodiments, the multi-video rendering engine includes (i) a multi-view output rendering engine for generating, from the virtual gaming universe (i.e. from the electronic representations of the virtual universe), one or more multi-view rendered video streams and (ii) at least one cropper for generating from said multi-view rendered video said plurality of video streams.

According to some embodiments, the presently disclosed system further includes (e) a plurality of video communications links for transmitting the plurality of rendered video streams to respective said client devices.

There is no explicit limitation on the video format or the video communications links. Exemplary communications links include but are not limited to switching network links (for example, packet-switched network links and/or circuit switched networks), multiple access link and direct point-to-point networks links.

Thus, according to various embodiments, the presently disclosed applications server array includes one or more video communications output (for example, for streaming video) adapted to sent data (i.e. rendered video) via one of the aforementioned networks.

It is now disclosed for the first time a client-server gaming system comprising (a) the plurality of client devices, and (b) the presently disclosed server-based system.

According to some embodiments, each client device includes addressing capability for forwarding input events to a configurable address (for example, an address associated with the application server array).

According to some embodiments, each client device includes (i) a display screen, and (ii) a video control mechanism (i.e. a configurable video control mechanism) for routing to the display screen at least one of locally rendered video and remotely rendered video derived from a said video stream.

According to some embodiments, the video control mechanism is operative to simultaneously display both said locally rendered video and said remotely rendered video.

According to some embodiments, each client device includes a data input mechanism for generating input events that are a precursor to said game commands.

According to some embodiments, the data input mechanism is a telephone keypad.

According to some embodiments, client device is configured to forward to said application server array external event data (i.e. data derived from external events).

One non-limiting example of external event data is incoming communication event data, though other examples are contemplated.

According to some embodiments, the incoming communication event data includes incoming voice communication event data.

It is now disclosed for the first time a method of providing a multi-player gaming environment to a plurality of client devices. The presently-disclosed method includes the steps of (a) providing within an application server array (i.e. separate from the client devices) a game engine for maintaining a virtual gaming universe including a plurality of user-controllable gaming characters, (b) at the application server array, receiving data indicative of game commands from a plurality of client devices, (c) associating each gaming character with gaming commands of a different respective client device (for example, such that the respective gaming character is controlled within the gaming universe at least in part by game commands provided by said respective client device), and (d) within the application server array, generating a plurality of rendered video streams, each video stream representing a game view associated with a respective said gaming character (for example, such that there is a one-to-one correspondence between video streams served to client devices and gaming characters).

It is now disclosed for the first time a system for providing a gaming service (for a single player or a plurality of players). The presently disclosed system comprises (a) an application server array adapted to effect a data transfer with each of one or more client devices that are each separate from said server array, (b) an input data aggregator for receiving data indicative of game commands from each said client device where for each client device respective game commands are derived from input received through a respective said data input module; (c) a game engine residing at least in part in said application server array for maintaining a virtual gaming universe including at least one controllable gaming characters, said gaming engine operative to associate each said gaming character with said game commands of a said respective client device; and (d) a video output rendering engine residing in said application server array for generating from the virtual gaming universe (i.e. from the electronic representations of the virtual universe) at least one video.

Typically, the video is rendered in real time, or substantially in real time, in order to provide a low-latency gaming experience. Thus, in some embodiments, only rendering operations associated with real-time rendering are carried out in the application server, though it is appreciated that this is not a limitation of the present invention.

Rendering in “real time” is typically carried out at substantially the same rate as the frame rate. In some examples (for example, where video is presented on the screen of a cellular telephone or a PDA), the frame rate is at least 8 frames per second, and, for example, at most 30 frames per second or 60 frames per second. In some examples (for example, where video is presented on a screen of a desktop or laptop computer), the frame rate is at least 60 frames per second. It is appreciated that in different examples, the frame rate may different, and thus, the rate of rendering in the application server may also differ.

In some embodiments, the system further includes an encoding engine for encoding video and a streaming server transferring the encoded video stream. Although not a limitation, in some embodiments, the encoding and streaming are effected in a ‘low latency’ manner (for example, a latency less than 200 ms).

In one example, the video is rendered in accordance with a view associated with a gaming character and/or a group of gaming characters and/or a “global view.” In one example, a gaming system provides a soccer game, and a stream of video associated with a “bird's eye view.” Thus, in some embodiments, the view is not associated with any gaming character, or may be associated with a plurality of gaming character's (in one example of a soccer game, there are 2 teams, each of which has a plurality of player's—one game view may be associated with a first team (for example, from their goal, or from an average position of their player), and a second game view may be associated with a second team).

It is now disclosed for the first time a method of providing a single player or multi-player gaming environment. The method presently disclosed method comprises: (a) providing within an application server array a game engine for maintaining a virtual gaming universe including at least one gaming character; (b) at said application server, receiving data indicative of game commands from at least one plurality of client devices; (c) associating each said gaming character with said data indicative of gaming commands received from a respective said client device (i.e. if receiving data from more than one said client device, then gaming commands from each different client device is associated with a different gaming character, if receiving data from one client device associating data indicative of game commands with one of the gaming characters); and (d) within said application server array, generating at least one rendered video streams, associated with a game view of said virtual gaming universe.

These and further embodiments will be apparent from the detailed description and examples that follow.

### BRIEF DESCRIPTION OF THE DRAWINGS

FIG. 1 provides a block diagram of an exemplary multi-player interactive gaming system in accordance with some embodiments of the present invention.

FIG. 2 provides a block diagram of an exemplary client device in accordance with some embodiments of the present invention.

FIG. 3A provides a block diagram of an exemplary application server array in accordance with exemplary embodiments of the present invention.

FIG. 3B provides a block diagram of an exemplary application server array including a video output rendering engine adapted to produce a stream of multiple view video and a cropper for splitting the stream into multiple streams.

FIG. 3C provides a schematic of a “multi-view” video with a plurality of windows within the stream.

FIG. 3D provides a block diagram of an exemplary single-player interactive gaming system in accordance with some embodiments of the present invention.

FIG. 4 provides a block diagram of an exemplary client device including a client rendering module for locally rendering video in accordance with some embodiments of the present invention.

### DETAILED DESCRIPTION OF THE INVENTION

The present invention will now be described in terms of specific, example embodiments. It is to be understood that the invention is not limited to the example embodiments disclosed. It should also be understood that not every feature of the system, method and computer-readable code for providing an electronic gaming environment for a multi-player game is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present inventor is now disclosing a system, method and computer-readable code for providing an electronic gaming environment for a multi-player game. Each human player accesses the gaming environment through a respective client device having a data input mechanism (for example, keyboard such as a phone keypad, or a trackball, or a joystick, etc.) and a display screen. These client devices effect a data transfer with an applicant server array separate from the client devices. Much of the computation for supporting the game environment is carried out within the application server array, and thus the client device functions as a “thin client” for accessing the gaming environment. In particular, the game engine itself may reside in the application server. Furthermore, video output may be rendered in the application server, and served to the client device 112, thereby offloading a portion of the computational load needed to maintain the gaming environment from the client device to the game application server array.

As used herein, when a first device “effects a data transfer” with a second device, the first device effects at least one of sending data to the second device and receiving data from the second device. In some embodiments, this refers to the situation where the first and second device send data to each other and receive data from each other.

Not wishing to be bound by theory, it is noted that in some examples, the computational load associated with rendering the video may be quite considerable, and thus the rendering of game video in the application server may obviate the need for substantial computational resources to be available on the client device. Thus, it is noted that in some embodiments, rendering the video on the application server may allow for the user to access gaming environments that the client device is otherwise incapable of providing.

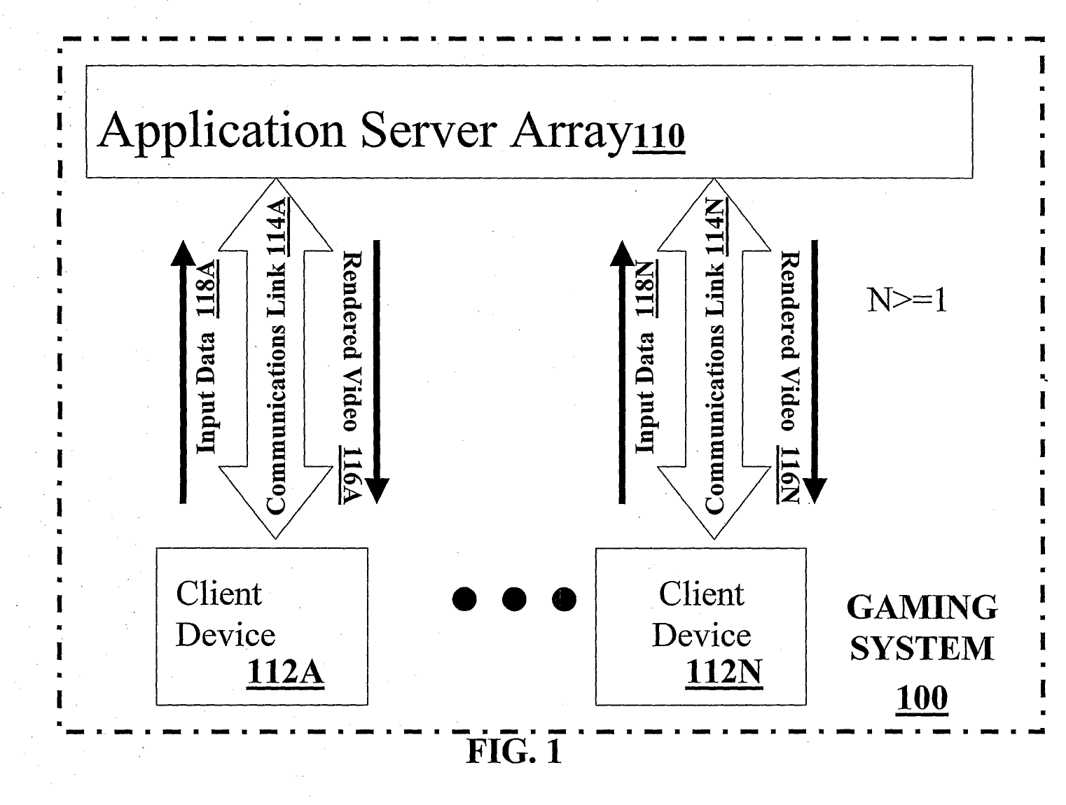

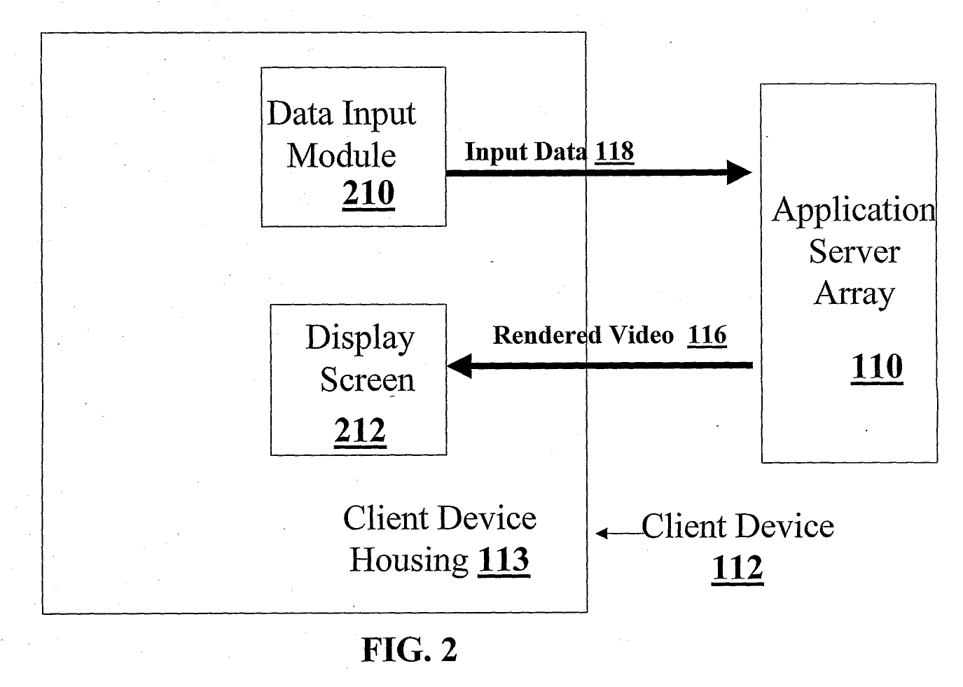

FIG. 1 provides a block diagram of exemplary multi-player interactive gaming system 100 in accordance with some embodiments of the present invention. Each human player enters game “commands” (for example, directives for a game character to perform a specific action within the virtual gaming universe, such as to move a “game character”) through a data input mechanism or module 210 of a client device 112 (see FIG. 2). According to the example described, there are one or more client devices 112 accessing the application server array.

Input data 118 including data indicative of these game commands are sent over a communications link 114 (for example, a ‘wireless’ communications link) to an array of one or more game application servers 110. The application game server array 110 (i.e. one or more application servers, in a centralized location, or distributed within a computer network, for example, including one or more game consoles) processes game commands received from a plurality of client devices and streams back to each client device a respective video stream 116. These video streams 116 are rendered in the application server before being sent (for example, over a high bandwidth connection) to the client devices 112 for display on the display screen 212

Typically, each client device 112 is used by a different human player who controls, using the client device, a different “game character(s)” of the game universe. The display screen 212 of the client device 112 thus provides the human player a view into the virtual universe of the game. In some embodiments, more than one client device 112 may be served identical (an/or substantially identical) rendered video streams 116.

Alternatively or additionally, different client devices are served different video, streams, which may vary in accordance with one or more of a number of factors. Exemplary factors include but are not limited to a point of view, a frame rate, a type of encoding, bandwidth, a client parameter (such as screen size and/or screen resolution), and user preferences.

Thus, in particular embodiments, each client device may be provided with a different view associated with the specific game character controlled by the specific client device. Thus, it is recognized that the rendered video 116 sent to each client device may be different, in accordance with the game character being played by the human player using the client device.

More specifically, each client device 112 may, in some embodiments, receive a respective rendered video 116 stream associated with the gaming character controlled by the game commands provided by the respective client device 112 and with respect to the client's physical capabilities and its connection. In particular embodiments, each rendered video stream 116 could provide a different “view” into the virtual gaming universe associated with the character controlled by the respective client device. It is noticed that this view may be a “first person” game view within the virtual universe associated with the respective controlled game character, or a “third person” game view within the virtual universe associated with the respective controlled game character. Other types of views (i.e. other than first person and third person) associated with a specific game characters may also be provided.

In particular embodiments, a view (and not just the administration of the virtual game universe) may be defined by the game engine 312. In one example, it is decided that if a certain player receives a certain number of points, he is “rewarded” with a deeper view (for example, the ability of to ‘see’ further) of the virtual universe. The skilled artisan will be able to provide numerous examples.

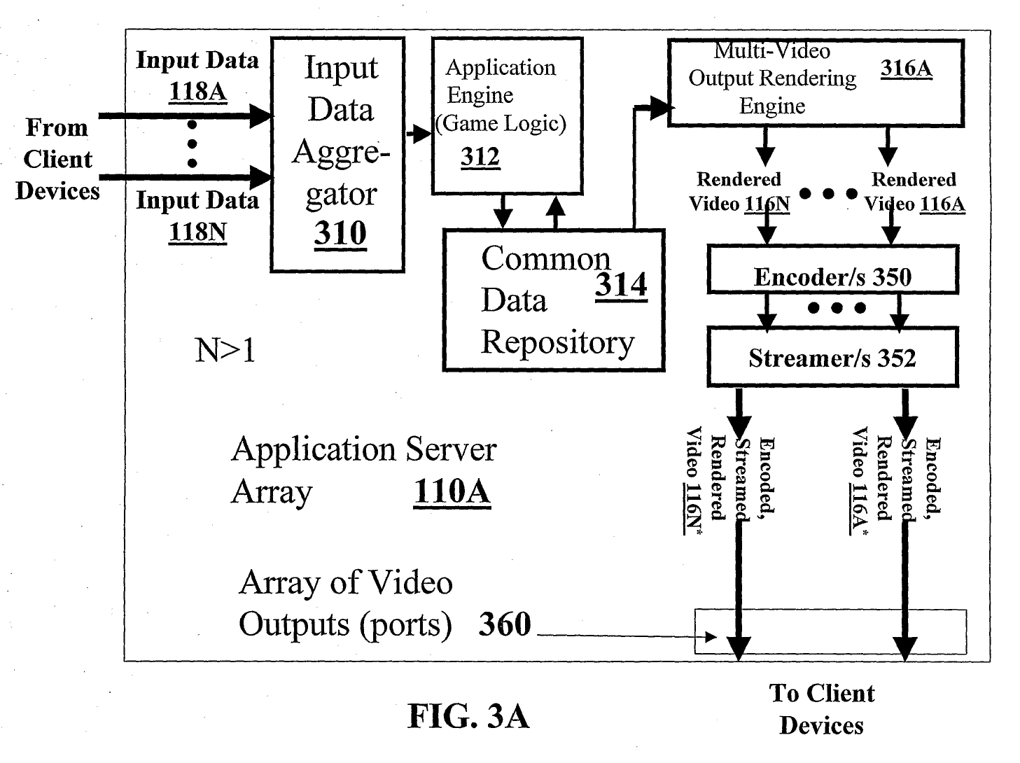

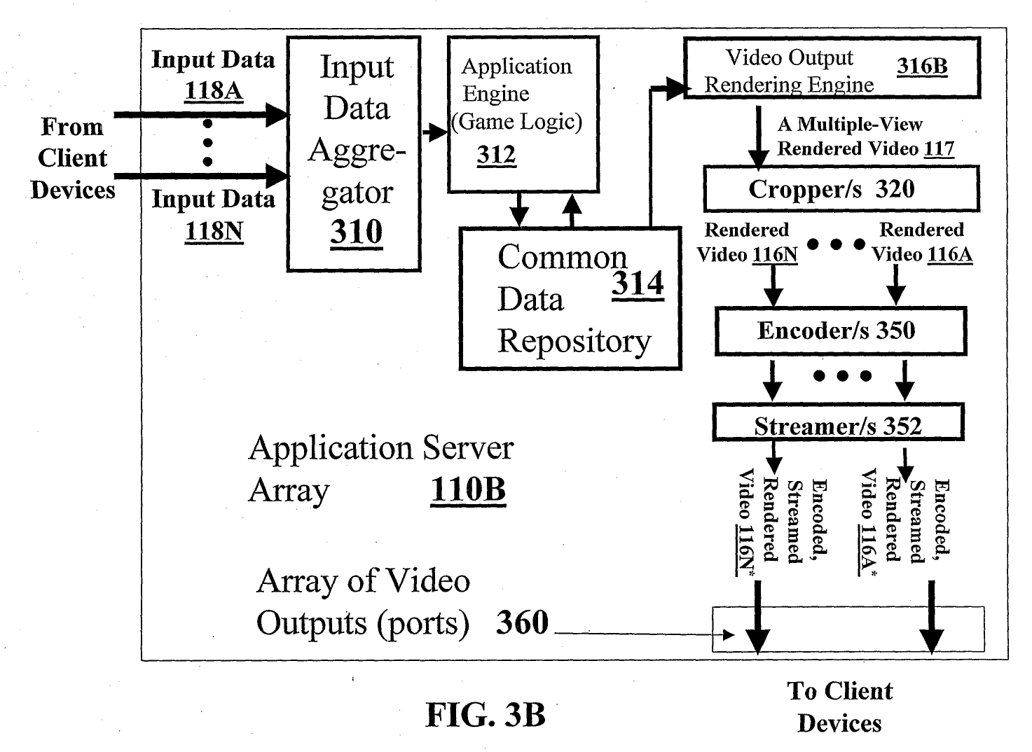

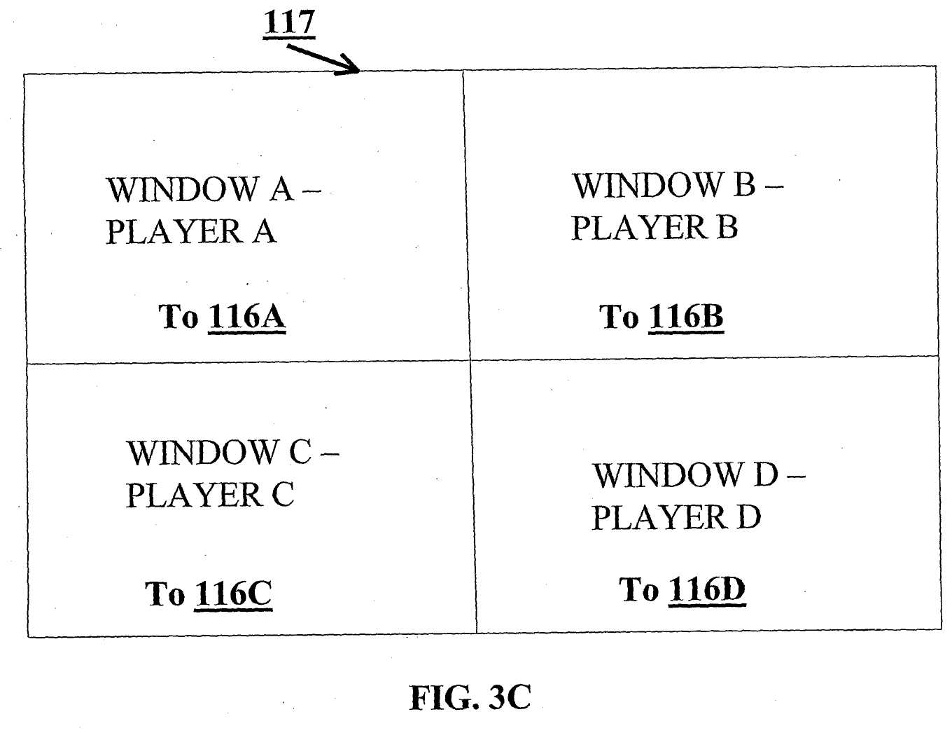

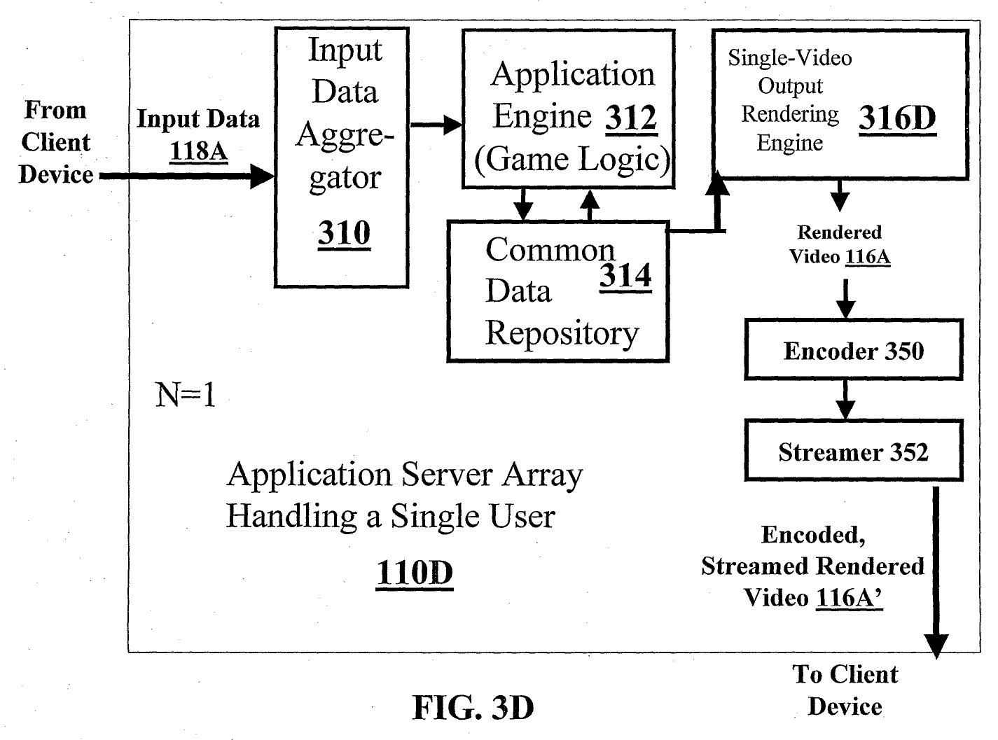

FIG. 3A provides a diagram of the application server array 110 in accordance with exemplary embodiments of the present invention. Although the application server array 110 drawn is a single entity having single instances of each component, it is appreciated that one or more of the components depicted (and/or multiple instances of each component) here may be located in different locations within a computer network. Furthermore, it is appreciated that the system may not be limited to a single application server array 110, and that there may be redundant application server arrays situated at different locations in the network.

Thus, referring to FIG. 3A, it is noted that input data from the plurality of client devices is received by an input data aggregator 310. The input data 118 includes the game commands from the client devices.

Application Engine 312 (Game Engine)

This data is made available to the application engine or game engine 312 which includes game logic (for example, a set of game rules, such as the rule that a bullet object that reaches a game character may injure or kill the game character or remove that “hit” game character from the game). Information about the current state of the game is stored in a common data structure or data repository 314. The data repository 314 may include the data necessary to represent or ‘model’ the virtual game universe, including but not limited to one or more of geometry data, viewpoint data, texture data and lighting information. Along with the aforementioned data, data related to the virtual universe that is stored in memory may also include game specific data.

The data repository may be implemented using any combination of volatile and non-volatile memory. In exemplary embodiments, the data repository may include status information about user-controlled game characters and/or computer ‘gamemaster’ controlled game characters (non-limiting examples of status information include one or more of the positions and/or orientations of each game character.

Thus, the game engine or application engine 312, in accordance with game logic, maintains the virtual game universe by maintaining and modifying the appropriate data structures within the common data repository 314 which represent the virtual universe in accordance with game logic. Although FIG. 3 depicts the input data as flowing directly to the application engine 312 from the input data aggregator 310 it is appreciated that this is in accordance with exemplary embodiments, and in other embodiments, the input data aggregator 310 is not directly linked to the application engine 312.

Application engines which including game logic 312 are well known in the art. Any game engine or application engine and any game engine architecture are appropriate for the present invention. In exemplary embodiments, the game engine may include one or more of a physics engine, an AI agent, and one or more game libraries, though embodiments with other game engine components are contemplated as well.

In some embodiments, the game engine 312 may modify the common data repository 314 representing the virtual universe in accordance with rules of the game application. In other words, the game engine 312 may update the common data repository 314 (i.e. effect a change to the virtual game universe) in accordance with input data 118 including game command data received from the client devices 112. According to one non-limiting example, if a game character is shot by another character, the character's “health” attribute is reduced and the character is partially disabled.

As illustrated in FIG. 1, each client device receives a stream of rendered respective video 116 from the application server array 110. Typically, but not necessarily, each rendered stream of rendered video 116 is different, in accordance with a view (i.e. third person or first person) associated with the respective gaming character associated with the respective client device 112.

Although certain embodiments have been explained in terms of each user controlling a “single” game character or entity, it is appreciated that in some embodiments, a plurality of users may control a single game character and/or a single user may control more than one game character.

Rendering of Video at the Application Server Array 110

Referring once again to FIG. 3A, it is noted that each stream of rendered video 116 may be generated by a multi-video output rendering engine 316A which is separate from the client device 112 (i.e. which resides within the application server array 110). In some embodiments, each respective video stream is associated with different view of the “virtual universe” of the “game world,” and as such, is generated directly or indirectly from the common data repository 314. According to the exemplary embodiment illustrated in FIG. 3A, a multi-video output rendering engine 316A capable of forming the plurality of video streams, is provided.

Alternatively or additionally, the streams produced by the multi-video output engine may be identical, or may vary in accordance with a number of a parameters other than the ‘view’ parameter (i.e. bandwidth, device parameters such as screen size, etc.)

There is no limitation on how the multi-video output rendering engine 316 simultaneously (or substantially simultaneously) renders the plurality of video streams 116. According to one example, each video stream is rendered ‘in parallel’ (for example, using redundant hardware and/or software components, etc).

Alternatively or additionally, the multi-video output rendering engine 316 is operative to render video frame by frame sequentially for all of the users in parallel. For example, the multi-video output rendering engine may “directly generate the video stream,” i.e. without the intermediate step of generating a multi-view video stream and then processing or cropping this multi-view video stream as explained below with reference to FIG. 31B. In some embodiments, in accordance with the block diagram of FIG. 3B, a “multi-view” video stream is first generated. For example, a “multi-view” video stream 117 with a plurality of windows within the stream may be generated (for example, see FIG. 3C), where each window is associated with a different respective view which is associated with input commands derived from a different respective client device (for example, video streams 116A, 116B, 116C and 116D which are each associated with a view for a different respective input device). This multi-view video stream 117 may then be forwarded to a cropper 320 which is configured to generates a plurality of rendered video streams 116 (for example, single-view video streams) from the multi-view video stream, each respective video stream (e.g. single-view video stream) is derived from a different window of the multi-view rendered 117 video stream, and may represent a different view of the game “virtual universe”.

Typically, the rendered video is encoded by an encoder 350 and then streamed by a video streamer 352 to the client device 112. There is no limit on the format of encoded video outputted by the encoder 350. Exemplary formats include but are not limited to MPEG4, MPEG2, JPEG and JPEG2000. In some embodiments, the video streamer 352 is operative to send a video file or files, and includes buffer management functionality.

Thus, it is noted that although it is not a requirement for the present invention, usually, encoded video (denoted with the ‘prime’—i.e. 116′) is served to each client device 112.

Although certain aspects of the present invention have been explained in terms of the case where there are a plurality of client devices served by the application server array, this is not a limitation, and some embodiments provide an application server for providing gaming services to a single device, as illustrated in FIG. 3D.

Rendering is a process of generating an image (for example, a raster graphics image, for example, a digital image) from the representation of the virtual universe, and may be carried out in software, hardware or any combination thereof. This term is well known in the art, and as noted by Wikipedia, “may be by analogy with an ‘artist's rendering’ of a scene”.

In some embodiments, the ‘rendering’ may also be accompanied with calculation of special effects (for example, sound) within the application server. These ‘special effects’ may then be associated with the rendered video 116 (for example, by embedding special effect data within a single data video stream or video file which is sent to one or more client devices).

The operations performed by the rendering engines may include any operation typically performed by a video rendering engine. Thus, in some embodiments, light transport calculations (for example, using a radiosity technique and/or a ray tracing technique) are effected (i.e. creation of a video image in accordance with the geometry and lighting of a given scene). Wikipedia has given a list of algorithms and techniques associated with rendering, and according to some embodiments of the present invention, video rendering operations may include one or more of the following (quoted, within minor modifications, from the Wikipedia article on “Computer Graphics: Rendering”) of the following, in any combination: shading (i.e. determining how the color and brightness of a surface varies with lighting), texture-mapping (i.e. a method of applying detail to surfaces), bump-mapping (i.e. a method of simulating small-scale bumpiness on surfaces), determining fogging/participating medium (i.e. determining how light dims when passing through non-clear atmosphere or air), shadowing (i.e. determining the effect of obstructing light), soft shadowing (i.e. determining varying darkness caused by partially obscured light sources), reflection calculations (i.e. determining mirror-like or highly glossy reflection), transparency calculations (i.e. computing sharp transmission of light through solid objects), determining translucency (i.e. determining highly scattered transmission of light through solid objects), determining refraction (i.e. computing bending of light associated with transparency), determining indirect illumination (i.e. for surfaces illuminated by light reflected off other surfaces, rather than directly from a light source), caustics (i.e. a form of indirect illumination) (determining reflection of light off a shiny object, or focusing of light through a transparent object, to produce bright highlights on another object), effecting a depth of field calculation (i.e. objects appear blurry or out of focus when too far in front of or behind the object in focus), effecting a motion blur calculation (i.e. objects appear blurry due to high-speed motion, or the motion of the camera), effecting a photorealistic morphing (i.e. photoshopping 3D renderings to appear more life-like), effecting a non-photorealistic rendering (rendering of scenes in an artistic style, intended to look like a painting or drawing).

Other non-limiting examples of video rendering operations include but are not limited to color calculation, texture calculation, shadow calculation, shading (i.e. defined by Wikipedia as “determining how color and/or brightness of an object or surface varies with lighting”), alpha blending, depth testing, and rastering. It is appreciated that many rendering engines may effect one or more rendering operations not listed herein.

Although rendering has been discussed in terms of rendering at least one ‘single’ image, it is appreciated that rendering typically this includes creation of an ‘animation’ of a plurality of video images.

All of the aforementioned components of the application server array 110 may be implemented as hardware, software, or any combination thereof. In exemplary embodiments, either the rendering engine may be implemented at least in part in hardware, for example, using one or more graphic accelerator cards (for example, video cards or screen cards, for example, a plurality of graphics cards in parallel) that reside within the application server array 110.

A Discussion of the Communications Link 114

Referring once again to FIG. 1, it is noted that although the communications link 114 is illustrated as a single bi-directional communications link, it is appreciated that in different embodiments, a plurality of communication links, including a link for uploading input data 118 to the application server array 110 and a link for downloading rendered streamed 116 to the client device 112, may be provided. In exemplary embodiments, a video compression engine may be provided on the server side, along with video decompression engines on the client side. In exemplary embodiments, a streaming server may be provided on the server side.

There is no limitation on the type of communications link 114 that may be used to transfer data between the application server array and the client device. Thus, in some embodiments, the application server array 118 and the client device 112 may communicate through a switched network, including but not limited to a packet switched network and a circuit switched network (telephony network) or/and a multiple access link network. For the purposes of this application, when two devices communicate through a switching network, the communication link between the devices is defined as a “switching network link.”

Alternatively, the communications link 114 may be other than a switching network link. For example, the client devices may communicate with the application server array using a “point-to-point”communications link (for example, a wireless point-to-point communications link) (for example, a communications link other than a switched or multiple access link communication).

Thus, it is appreciated that both local and wide networks of any type are within the scope of the basic invention. Exemplary communications networks include but are not limited to WiMax, Wi-Fi, Bluetooth, high performance wired or wireless networks such as WLAN (wireless LAN), WAN (including WWAM) other than a telephony network.

A Discussion of Exemplary Client Devices 112

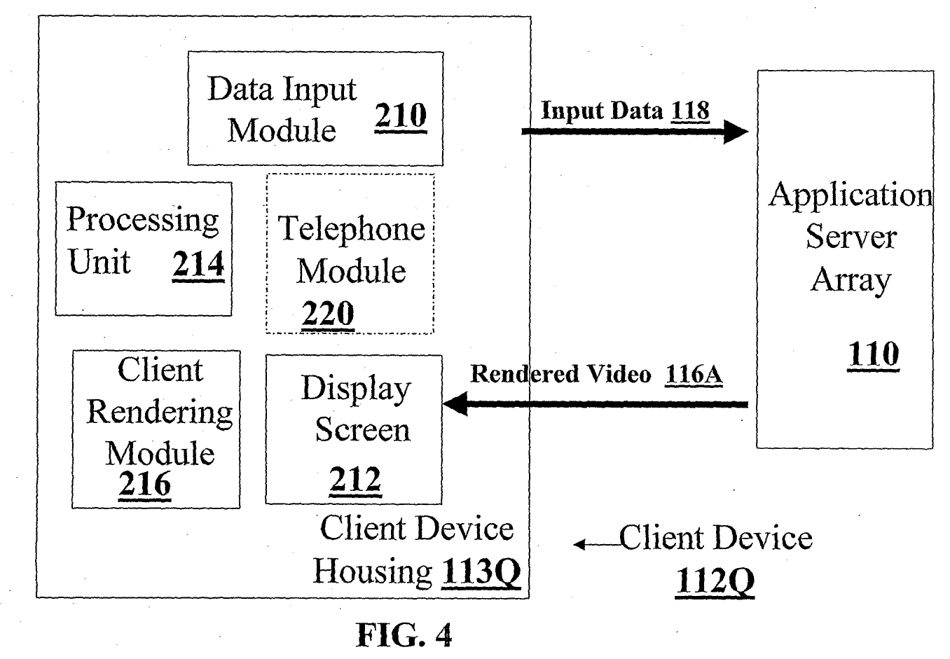

FIG. 4 provide a block diagram of an exemplary client device 112 (for example, a mobile telephone such as a 3G cellular telephone or a personal digital assistance) in accordance with some embodiments of the present invention. Thus, referring to FIG. 4 it is noted that the exemplary device may includes a data input module 210, a processing unit 214, a client rendering module 216, and a display screen 212 as well as other modules.

It is noted that although the device of FIG. 4 posses its own video rendering module 216, game video is, nevertheless, rendered in the application server array 110. The present inventors note that there are many situations where the client rendering module 216 lacks the necessary computational resources for rendering “complicated” video content, for example, “realistic” graphics or video contenting featuring sophisticated special effects. Thus, in many situations, without the systems, methods and code of the present invention, the user may be limited by what types of games she may play on the client device due to the limitations of the client side rendering module 136. The present inventor is disclosing, for the first time, a system, method and computer-readable code that provides an environment where multi-user games featuring or requiring this more “complicated” video content may be played on such client devices 112 despite the limitations of the rendering module 136.

Thus, input data 118 generated by the data input module 210 including game commands is routed to the application server array 110 while pre-rendered video 116 generated in accordance to the game commands received from one or more (typically all) client devices 112. The received “pre-rendered” video 116 is then displayed on display screen 132 with little or no need for the client-side rendering module 136.

Typically, the video stream formed in the application server array 112 is ready for display on the client without any further post-processing. Nevertheless, the present invention does not exclude limited ‘post-processing’ rendering operations performed by the client device 112 after receiving a video stream 116, for example, by the client rendering module 212 and/or the processing unit 214. For cases where this occurs, it is noted that, typically, a ratio between a quantity of computational resources (i.e. simple addition operations) expended in the ‘post-processing’ carried out on the client is at most a given percentage of the quantity of computational resource expended forming a respective video stream (i.e. that is sent to the client device) in the application server array. In some embodiments, this ‘given percentage’ is 20%. Alternatively, in various embodiments, this given percentage may be 10%, 5% or 1%.

Client-Side Applications

In exemplary embodiments, one or more applications reside on the client device 112. In one user scenario, the client side rendering module may be used for “normal” operation of the device (i.e. not required for use in gaming system 100). In a particular scenario, video content of the multi-user game, rendered in the application server array, may be displayed on the display screen 132 simultaneously with other, unrelated content (for example, a message indicating an incoming SMS or an incoming phone call) which is rendered locally on the client-side rendering module 136.

Thus, in exemplary embodiments, one or more applications (for example, operating system software such as Windows Mobile or any other operating system, or an application residing within an environment maintained by the operating system) may reside within the client 112Q device of FIG. 4. The application may be implemented as any combination of software, hardware and firmware. In exemplary embodiments, application instructions are executed by the processing unit 214 (for example, a processing unit including a CPU). In some embodiments, the total amount of processing power residing within the client device 112 is less than the amount of processing power required to render the respective stream of video 116 received by the client device by at least a factor of 2. In particular embodiments, the total amount of processing power within the client device 112 is less than the amount of processing power required to render the respective stream of video 116 received by the client device by at least a factor of 5.

In some embodiments, an application residing within the client device may include addressing capability for forwarding input data derived from user input detected by the data input module 210 to a specific server, such as a server of the application server array 110. This addressing capability may, in exemplary embodiments, by “configurable”—i.e. the application may include code for forwarding input data to a changeable specifiable address, rather than a single “hardcoded” destination.

In some embodiments, the application residing within the client device 112 may provide screen management functionality. For example, in some embodiments, a local application (non-limiting examples include but are not limited to a browser, an email application, another game other than the game of Gaming System 100, a “mobile office” style application, etc) may reside within the client device 112. Furthermore, in these embodiments, video associated with the “local application” a displayed on the client device display screen 212 may be rendered by a local client rendering module 216 residing within the client device 112.

Screen Management Mechanism

Thus, according to exemplary embodiments, a screen management mechanism (not drawn) is provided within the client device. The screen management mechanism may include a video control mechanism for routing to the display screen at least one locally rendered video and remotely rendered video (i.e. rendered video 116 or video derived from the rendered video 116). According to one example, when the user is not playing the game of the gaming system 100, locally rendered video (i.e. rendered by client rendering module 216) is display on display screen. When the user “registers” or logs into the multi-player game of gaming system 100 (for example, using a registration application residing at least in part in the client device), at some point (i.e. before, during or after the registration process) the screen management mechanism configures the display screen 212 to display video 116 rendered in the application server array. In some embodiments, this configuration may be a reversible configuration, and at some later time, the display screen 212 no longer displays the video 116 rendered in the application server array. This could happen, for example, upon receiving a directive to exit the game.

In some embodiments, the screen management mechanism displays rendered video 116 produced in the application server array on the display screen 212 simultaneously with locally rendered video rendered by the client rendering module 216. Alternatively or additionally, the screen management mechanism may be operative to “overlay” both locally rendered video and video served from the application server array 110.

In one example, the client device includes an optional telephone module 220. Thus, according to exemplary embodiments, an application residing on the client device 112 is operative to inform the user an incoming message (voice and/or text message) by displaying an indication of the incoming message on the display screen 212.

Suspending and/or Blocking Game Play

In some embodiments, application code (residing anywhere, including the client device or the application server array) is operative to temporarily “block” the game service, for example in accordance with an any ‘external events’ (i.e. events other than events related to the game provided by the gaming system 100) such as incoming messages. In exemplary embodiments, the client device is operative to forward information about the external events and/or information derived from or triggered by external events to the application server array 110.

In one example, the entire game may “freeze” while one or more users are blocked. Alternatively or additionally, the application code may be operative to block other services of the client device 112 when the multi-player game of gaming system 110 is being played on the client device, or in accordance with one or more events that occur in the multi-player game of gaming system 110 (for example, when one or more events occur in the virtual gaming universe, or one or more conditions of the gaming system are satisfied (i.e. when there are more than a certain number of users playing)), or in accordance with any other conditions.

Returning to the case where the application is operative to “block” the game on a given client device (for example, by not deriving game commands from the user's physical interactions with the data input module 210 and/or, for example, by temporality disregarding the user's physical interaction with the data input module 210, and/or for example, by disregarding generated game commands at the server side), it is noted that in some embodiments, a game character control mechanism (i.e. residing at least in part in the client device 112 and/or residing at least in part in the application server array 110) may be provided to ‘auitomatically’ control the blocked user's gaming character within the virtual gaming universe in the interim. During the time that the game is blocked, the user's participation in the multi-player game is suspended (i.e. because the user's client device is ‘blocked’), and the game character control mechanism may “automatically” control the user's gaming character.

It is noted that the providing of the game character control mechanism may minimize the impact on other users of the multi-player when one player “leaves” the virtual game universe temporarily or otherwise. In exemplary embodiments, the gaming system 100 is configured such that a user may re-gain control of the respective gaming character (i.e. resume playing the game) controlled by her client device.

Although an embodiments where the game play on a client device 112 is blocked upon receiving a communication (voice or text), it is noted that other embodiments, providing a mode where the incoming communication is handled by the client device 112 without user input and the user is free to continue (i.e. even upon receiving a voice communication) playing the multi-user game are contemplated.

Different Types of Client Devices and/or Differently Configured Client Devices Used Simultaneously within the Game System 100

Referring once again to FIG. 1, it is noted that in exemplary embodiments, respective client devices are not identical devices. For example, the client devices may be provided by different manufacturers and may be different models. Thus, in exemplary embodiments, different client devices 112 may each have a data input module 210 and/or different screens. In some embodiments, a display screen (and/or other video display hardware) of devices may vary, and rendered video 116 will need to be provided to each device in accordance with the respective properties of each device. Thus, in some embodiments, the multi-video output rendering engine 316 may be configured to generate rendered video for specific devices in accordance with the device settings of a targeted device. Display encoding and video parameters may vary as well.

In another example, different operating systems and/or application environments (non-limiting examples include Java and BREW) are provided on different respective client devices.

Furthermore, the specifics of the data input modules 210 may vary between devices as well. In one example, one client device 112 includes a telephone keypad, and another client device 112 includes a joystick or a touch-screen. In another example, each client device 112 includes a telephone keypad, but different users may wish to configure their client devices differently. For example, in a game where a game character can move within a gaming universe, one player may wish to assign the “7” key to leftward motion of a gaming character and the “9” key to rightward motion, while another player may wish to assign the “4” key to leftward motion of a gaming character and the “6” key to rightward motion. Thus, in one example, the application server array 110 is configured to “translate” the respective key depressions sensed on the client device into game commands in accordance with a mapping for a particular client device. This mapping may change in time and may vary from time to time. Alternatively or additionally, the “translation map” between key depressions and game commands may reside on the client device. The mapping may be implemented on the client device, on the server side on both or partially in both.

In exemplary embodiments, a device configuration mechanism (i.e. operative to configure the client device 112 and/or an application environment of the client device 112 and/or how input signals from a particular client device is handled may be provided. This may, for example, be determined during a “registration process” either using software residing within or served to the client device 112. Alternatively or additionally, this may be determined ‘automatically’ by, for example, sniffing the type of client device, or by invoking a particular users device settings as stored in the client device 112 or within the application server array.

An Additional Discussion about Application Server 110 Architecture

Until now, the system has been explained in terms of a single application server array 110. It is noted that the application server array need not reside in a single location, and may reside on a plurality of machines, either local to each other or distributed through a network. Furthermore, in FIG. 3, single instances of each component are depicted, though this is not a limitation of the present invention. In one example, multiple instances of the input data aggregator 310 (and/or an input data aggregator 310 ‘distributed’ through the network) is provided. According to this example, the input data aggregator 310 may reside on ‘host servers’ distributed through the network and operatively linked to ‘game servers’ which host the application engine 312. Moreover, there may be redundancies (for example, hardware redundancies) to provide fault resilience.

In addition, there may be redundant application server arrays situated at different locations in the network (for example, one set of application server arrays in New York and one set of application server arrays in San Francisco). Typically, these application server arrays may exchange data with each other in order to maintain integrity of the common application data structure 120 to provide a consisting virtual world for gamers accessing each server. This data exchange could include forwarding the input device from each client device to each application server. Alternatively or additionally, the data exchange may include exchanging common application data structure (i.e. “synchronizing” the data of the redundant data structure residing on each server with each other).

There are a number of scenarios where one might prefer to use redundant application servers. For example, it may be decided that such an architecture uses fewer bandwidth resources because exchanging input data and/or common application data structure data may be more bandwidth efficient than distributing video content to different locations in the network (for example, locations within the network which are “far” from each other).

Throughout this disclosure, it is noted that each client device may be associated with a respective gaming character. It is noted that, during the course of the game, the gaming character associated with a specific client device may change. In one example, the game is a single player or multi-player soccer game, and gaming characters are soccer players. At one point, a certain user's gaming device may be associated with one specific gaming character (a particular soccer player, such as a goalie). At a later stage in play, certain user's gaming device may be associated with a different specific gaming character (for example, an attacker). This “association switch” may be triggered, for example, in accordance with a user request, or by the gaming engine (for example, in accordance with the position of the ball on the field).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

1-92. (canceled)

93) A server-based system for providing gaming services, the system comprising:
a) an application server array adapted to effect a data transfer with each of a plurality of client devices that are each separate from said server array;
b) an input data aggregator for receiving data indicative of game commands from each of the plurality of client devices;
c) a game engine for maintaining a virtual gaming universe including a plurality of controllable gaming characters, said gaming engine operative to associate each said gaming character with said game commands of a respective client device; and
d) a multi-video output rendering engine residing in said application server array for generating from said virtual gaming universe a plurality of video streams each said video stream representing a view associated with a respective said game character.

94) The system of claim 93 wherein said multi-video rendering engine is configured to render said plurality of video streams directly from said virtual gaming universe.

95) The system of claim 93 wherein said multi-video rendering engine includes:
i) a multi-view output rendering engine for generating from said virtual gaming universe one or more multi-view rendered video streams;
ii) at least one cropper for generating from said multi-view rendered video said plurality of video streams.

96) The system of claim 93 further comprising:
e) a plurality of video communications outputs for transmitting the plurality of rendered video streams to respective said client devices.

97) The system of claim 96 wherein at least one said video communications output is adapted to transmit rendered video via a switching network to at least one said client device.

98) The system of claim 96 wherein at least one said switching network outputs is adapted to transmit rendered video via a direct point-to-point network to at least one said client device.

99) The system of claim 93 wherein the system is adapted to send to each said client device a respective said rendered video stream.

100) The system of claim 93 wherein said game engine resides at least in part in said application server.

101) The system of claim 93 wherein said generating of said video stream by said rendering engine includes at least one of color calculation, texture calculation, shadow calculation, alpha blending, depth testing, and rastering, or any combination thereof.

102) The system of claim 93 wherein said generating of said video stream by said rendering engine includes effecting a light transport calculation.

103) The system of claim 93 wherein said generating of said video stream by said rendering engine includes effecting one or more of determining shading, texture-mapping, bump-mapping, determining fogging/participating medium, shadowing, soft shadowing, reflection calculations, transparency calculations, determining, determining refraction, determining indirect illumination, effecting a depth of field calculation effecting a motion blur calculation, effecting a photorealistic morphing, and effecting a non-photorealistic rendering, or any combination thereof.

104) A system for providing a single-user or multi-user gaming service, the system comprising:
a) an application server array adapted to effect a data transfer with one or more client devices that are each separate from said server array;
b) an input data aggregator for receiving data indicative of game commands from each said client device;
c) a game engine residing at least in part in said application server array for maintaining a virtual gaming universe including at least one controllable gaming characters, said gaming engine operative to associate each said gaming character with said game commands of a said respective client device; and
d) a video output rendering engine residing in said application server array for generating from said virtual gaming universe at least one video stream.

105) The system of claim 104 wherein the system is adapted to send to each said client device a said rendered video stream.

106) The system of claim 105 wherein the system is adapted to send different said video streams to different respective client devices.

107) The system of claim 104 further comprising:
e) at least one video communications output for transmitting the plurality of rendered video streams to respective said client devices.

108) The system of claim 107 wherein at least one said video communications output is adapted to transmit rendered video via a switching network to at least one said client device.

109) The system of claim 107 wherein at least one said switching network outputs is adapted to transmit rendered video via a direct point-to-point network to at least one said client device.

110) A method of providing a multi-player gaming environment, the method comprising:
a) providing within an application server array a game engine for maintaining a virtual gaming universe including a plurality of gaming characters;
b) at said application server, receiving data indicative of game commands from a plurality of client devices;
c) associating each said gaming character with said gaming commands of a different respective said client device;
d) within said application server array, generating a plurality of rendered video streams, each said video stream representing a game view associated with a respective said gaming character.

111) The method of claim 110 wherein said plurality of rendered video streams are directly rendered from said virtual gaming universe.

112) The method of claim 110 further comprising:
e) transmitting the plurality of rendered video streams to respective said client devices.

113) The method of claim 112 wherein said transmitting includes sending data via a switching network to at least one said client device.

114) The method of claim 112 wherein said transmitting includes sending data via a direct point-to-point network.

115) A method of providing a single player or multi-player gaming environment, the method comprising:
a) providing within an application server array a game engine for maintaining a virtual gaming universe including at least one gaming character;
b) at said application server, receiving data indicative of game commands from at least one of client device;
c) associating each said gaming character with said data indicative of gaming commands received from a respective said client device;
d) within said application server array, generating at least one rendered video stream, associated with a game view of said virtual gaming universe.
